(19) United States
(12) Patent Application Publication
(10) Pub. No.: US 2021/0026343 A1
(43) Pub. Date: Jan. 28, 2021

(54) INFORMATION PROCESSING DEVICE, INFORMATION PROCESSING METHOD, AND PROGRAM

(71) Applicant: NEC CORPORATION, Tokyo (JP)

(72) Inventors: Takashi KONASHI, Tokyo (JP); Satoru YAMANO, Tokyo (JP)

(73) Assignee: NEC CORPORATION, Tokyo (JP)

(21) Appl. No.: 16/982,623

(22) PCT Filed: Mar. 30, 2018
(86) PCT No.: PCT/JP2018/013985

§ 371 Date: Sep. 21, 2020

(51) Int. Cl. G05B 23/02

(52) U.S. Cl. CPC G05B 23/0259

(57) ABSTRACT

An information processing device includes: an acquisition unit that acquires a communication packet used for monitoring and controlling a system and process data collected from an apparatus installed in the system via a network; and a detection unit that detects an abnormal communication pattern on the network based on a correspondence between a communication pattern related to the communication packet and the process data.

### TECHNICAL FIELD

The present invention relates to an information processing device, an information processing method, and a program.

### BACKGROUND ART

Patent Literature 1 discloses an anomaly detection device targeted to a control network in an industrial control system such as a power plant. This anomaly detection device stores in advance a normal communication pattern between apparatuses for each operation mode such as a program mode, a running mode, a maintenance mode, or the like and detects, as an anomaly, a communication that does not match the normal communication pattern of the current operation mode.

### CITATION LIST

### Patent Literature

PTL 1: Japanese Patent No. 5844944

### SUMMARY OF INVENTION

### Technical Problem

In an industrial control system, however, the control method of an apparatus is not constant even in the same operation mode and has various states as a system, and there may be a wide variety of normal communication patterns. In the technique of Patent Literature 1, since anomaly detection is performed by using a uniform normal communication pattern for respective operation modes, it is difficult to accurately perform anomaly detection when there are multiple system states in a certain operation mode.

The present invention has been made in view of the above problem and intends to provide an information processing device, an information processing method, and a program that can accurately perform anomaly detection in an industrial control system.

### Solution to Problem

According to one example aspect of the present invention, provided is an information processing device including: an acquisition unit that acquires a communication packet used for monitoring and controlling a system and process data collected from an apparatus installed in the system via a network; and a detection unit that detects an abnormal communication pattern on the network based on a correspondence between a communication pattern related to the communication packet and the process data.

According to another example aspect of the present invention, provided is an information processing method including steps of: acquiring a communication packet used for monitoring and controlling a system and process data collected from an apparatus installed in the system via a network; and detecting an abnormal communication pattern of the communication packet on the network based on a correspondence between a communication pattern related to the communication packet and the process data.

According to another example aspect of the present invention, provided is a program that causes a computer to perform steps of: acquiring a communication packet used for monitoring and controlling a system and process data collected from an apparatus installed in the system via a network; and detecting an abnormal communication pattern of the communication packet on the network based on a correspondence between a communication pattern related to the communication packet and the process data.

According to another example aspect of the present invention, provided is an information processing device including: an acquisition unit that acquires a communication packet used for monitoring and controlling a system and process data collected from an apparatus installed in the system via a network; and a learning unit that creates a model used for detecting an abnormal communication pattern of the communication packet on the network based on a correspondence between a communication pattern related to the communication packet and the process data.

According to another example aspect of the present invention, provided is an information processing method including steps of: acquiring a communication packet used for monitoring and controlling a system and process data collected from an apparatus installed in the system via a network; and creating a model used for detecting an abnormal communication pattern of the communication packet on the network based on a correspondence between a communication pattern related to the communication packet and the process data.

### Advantageous Effects of Invention

According to the present invention, an information processing device, an information processing method, and a program that can accurately perform anomaly detection in an industrial control system are provided.

### BRIEF DESCRIPTION OF DRAWINGS

FIG. 1 is a block diagram illustrating a schematic configuration of an industrial control system according to a first example embodiment.

FIG. 2 is a block diagram of an anomaly detection device according to the first example embodiment.

FIG. 3 is a detailed block diagram of a determination unit according to the first example embodiment.

FIG. 4 is a detailed block diagram of a packet learning unit according to the first example embodiment.

FIG. 5 is a schematic diagram illustrating a feature space of process data according to the first example embodiment.

FIG. 6 is a table illustrating an example of a model according to the first example embodiment.

FIG. 7 is a hardware block diagram of the anomaly detection device according to the first example embodiment.

FIG. 8 is a flowchart illustrating the operation of the anomaly detection device according to the first example embodiment.

FIG. 9 is a flowchart illustrating the operation of the determination unit according to the first example embodiment.

FIG. 10 is a flowchart illustrating the operation of the packet learning unit according to the first example embodiment.

FIG. 11 is a flowchart illustrating the operation of the anomaly detection device according to the first example embodiment.

FIG. 12 is a flowchart illustrating the operation of the determination unit according to the first example embodiment.

FIG. 13 is a flowchart illustrating the operation of the detection unit according to the first example embodiment.

FIG. 14 is a schematic configuration diagram of an information processing device according to a second example embodiment.

FIG. 15 is a schematic configuration diagram of an information processing device according to a third example embodiment.

### DESCRIPTION OF EMBODIMENTS

### First Example Embodiment

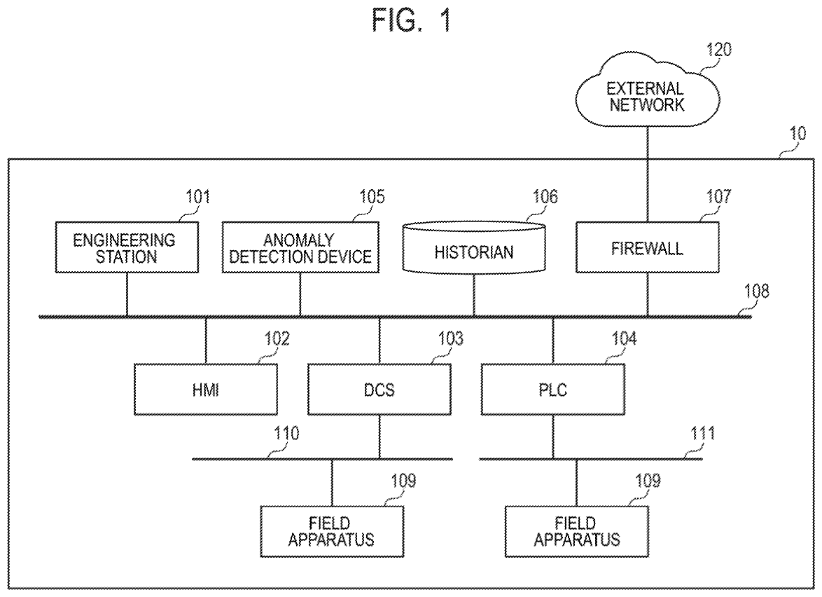

FIG. 1 is a block diagram illustrating a schematic configuration of an industrial control system according to the present example embodiment. The industrial control system 10 is a computer system that monitors and controls various plant systems such as a thermal power plant, a chemical manufacturing plant, or the like. The industrial control system 10 has an engineering station 101, a Human Machine Interface (HMI) 102, a Distributed Control System (DCS) 103, a Programmable Logic Controller (PLC) 104, an anomaly detection device 105, a historian 106, a firewall 107, a control network 108, field apparatuses 109, a field network 110, and a field network 111.

The engineering station 101 is a terminal that creates a control program used in the industrial control system 10 and writes a program in the HMI 102, DCS 103, or the PLC 104. The HMI 102 is a terminal that displays a system state (running status) or the like of a plant system to be monitored and controlled based on a program written from the engineering station 101 and is used for performing control such as checking of the running status, adjustment of an operation parameter of a system, setting change of the field apparatuses 109, or the like by an operator. Specifically, the HMI 102 transmits a communication packet including various command to the engineering station 101, the DCS 103, the PLC 104, and the historian 106 and receives a communication packet responding thereto. The command may be a command for transmitting data used for display to the DCS 103 and the PLC 104, a command for setting a register or the like of the field apparatuses 109 to the DCS 103 and the PLC 104, or the like. Thereby, the HMI 102 receives data used for display from the DCS 103 and the PLC 104 and displays the data, for example. Further, in response to a change of a setting value, the HMI 102 transmits the setting value to the DCS 103 and the PLC 104. The DCS 103 and the PLC 104 then set the setting value in the field apparatuses 109.

The DCS 103 is connected between the control network 108 and the field network 110 and performs control of the field apparatus 109 based on a program written from the engineering station 101. For example, the DCS 103 transmits a communication packet including a command to the field apparatus 109 as required or at intervals of several hundred milliseconds to several seconds and receives a communication packet responding thereto. Further, the DCS 103 receives a communication packet autonomously transmitted by the field apparatus 109. The number of DCSs 103 is not particularly limited.

The PLC 104 is connected between the control network 108 and the field network 111. The field network 111 is a network separated from the field network 110 described above. The PLC 104 controls the field apparatus 109 based on a program written from the engineering station 101. For example, the PLC 104 transmits a communication packet to the field apparatus 109 as required or at intervals of several hundred milliseconds to several seconds and receives a communication packet responding thereto. Further, the PLC 104 receives a communication packet autonomously transmitted by the field apparatus 109. The number of PLCs 104 is not particularly limited. Note that the industrial control system 10 may include only either one of the DCS 103 and the PLC 104. Further, the PLC 104 may be connected under the control of the DCS 103, and the field apparatus 109 may be connected to the end thereof.

The anomaly detection device 105 monitors a communication pattern of one or more communication packets transmitted between the engineering station 101, the HMI 102, the DCS 103, the PLC 104, and the historian 106 and detects an anomaly of the communication pattern. Herein, the communication pattern is formed of a single communication packet or a series of communication packets (sequence) having a periodicity and ordering. The anomaly detection device 105 determines a system state of a plant system based on a payload of communication packets flowing in a network or data acquired from the historian 106. Furthermore, the anomaly detection device 105 uses a model created in advance in accordance with a system state to determine whether or not an appropriate communication packet is transmitted.

When one or more abnormal (unauthorized) communication packets are transmitted to the DCS 103 or the PLC 104 due to a cyberattack or the like, a characteristic of the communication pattern for the communication packets will differ from the normal time characteristic of the system state (normal characteristic). For example, compared to the normal characteristic, a change in which the occurrence frequency of a particular communication pattern increases, a communication pattern not expected in the current system state occurs, or the like may occur. The anomaly detection device 105 can detect such a change in the characteristic of a communication pattern to determine whether or not a control anomaly is occurring. The abnormal communication pattern may be not only an unauthorized communication pattern due to a cyberattack but also a communication pattern output by an anomaly of an apparatus or the like.

Note that it is assumed in the present example embodiment that the anomaly detection device 105 is connected to the control network 108 and an abnormal communication pattern in the control network 108 is detected, however the example embodiment is not limited to such a configuration. The anomaly detection device 105 may be connected to the field networks 110 and 111 and configured to detect communication packets of an abnormal communication pattern transmitted between the DCS 103 or the PLC 104 and the field apparatus 109.

The historian 106 is a device that stores sensor data, actuator data, alarm information, or the like collected from the DCS 103, the PLC 104, the HMI 102, or the like as multi-dimensional time-series data.

The firewall 107 is a software component or an apparatus that is installed on the boundary between the industrial control system 10 and the external network 120 such as the Internet and protects the industrial control system 10 from an external attack by monitoring internal and external communication. That is, the firewall 107 has a security function that suppresses a cyberattack or the like from the external network 120 against the industrial control system 10. For example, the firewall 107 monitors an Internet Protocol (IP) address, a port number, or the like of a communication packet passing through the firewall 107 and performs filtering of the communication packet in accordance with a preset condition.

The control network 108 is connected to the engineering station 101, the HMI 102, the DCS 103, the PLC 104, the anomaly detection device 105, the historian 106, and the firewall 107. The connection scheme may be a wired scheme or a wireless scheme. For example, the control network 108 transmits a communication packet including data used for display to the HMI 102, a communication packet including information on settings of the field apparatus 109 to the DCS 103 or the PLC 104, a communication packet used for synchronization with the DCS 103 (or the PLC 104), or the like.

Note that the control network 108 may be connected to an information network (not illustrated) installed in an office or the like via the firewall 107. The information network may include a personal computer (PC), a file server, a Web server, a mail server, a printer, or the like and may be connected to a control network of another plant.

Each of the field apparatuses 109 is an apparatus such as a sensor, a valve, an actuator, or the like installed in a plant system. The sensor may be, for example, a temperature sensor, a pressure sensor, a flowrate sensor, a rotational rate sensor, a composition sensor, or the like. The valve may be, for example, a pressure control valve, a flowrate control valve, a closure valve, or the like. The actuator may be, for example, a pump, a fan, or the like. Note that the number and the type of the field apparatuses 109 are not limited, and around several hundreds to several thousands of different field apparatuses 109 may be included.

Each field apparatus 109 is controlled in accordance with a setting of an actuator and outputs a measurement value of a sensor. The actuator data includes an operation amount or the like such as a valve aperture, for example. The actuator data may be set as required or in a cycle of intervals of several hundred milliseconds to several seconds, for example. Further, the sensor data includes, for example, a temperature, a pressure, a flowrate, a water level, a rotational rate, a quality (composition) of a raw material, or the like. The sensor data may be acquired at intervals of several hundred milliseconds to several seconds, for example.

Sensor data and actuator data indicate states of measurement and settings in a plurality of field apparatuses 109 installed in a plant system. The anomaly detection device 105 analyzes the state of the field apparatuses 109 and thereby can recognize a detailed system state (running status) of a plant system to be monitored and controlled by the industrial control system 10. In the present example embodiment, description will be provided below with sensor data and actuator data being collectively referred to as “process data”. Note that the process data may include alarm information collected from the HMI 102 or a mean value, a dispersion, a standard deviation, a temporal change (differential value), an accumulated value (integrated value), or the like of the process data. Details of the sensor data and the actuator data will be described later.

The field network 110 is connected to the DCS 103 and the field apparatus 109. Similarly, the field network 111 is connected to the PLC 104 and the other field apparatus 109. The connection scheme may be a wired scheme or a wireless scheme. Further, each of the field networks 110 and 111 may be a field bus based on bus connection or serial communication such as RS-485. Each of the field networks 110 and 111 is used for performing communication between the above devices and transmits a communication packet including actuator data used for controlling the field apparatus 109, a communication packet including sensor data measured by the field apparatus 109, or the like, for example. Note that the DCS 103 and the PLC 104 may be connected to the same field network.

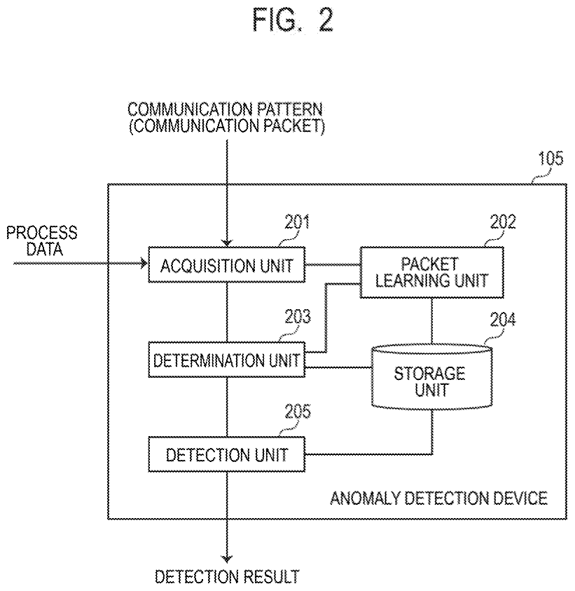

FIG. 2 is a block diagram of the anomaly detection device 105 according to the present example embodiment. The anomaly detection device 105 includes an acquisition unit 201, a packet learning unit 202, a determination unit 203, a storage unit 204, and a detection unit 205. The anomaly detection device 105 performs learning in advance based on a communication packet and process data (sensor data and actuator data) and performs anomaly detection based on a learning result.

The acquisition unit 201 acquires communication packets transmitted by the control network 108 during learning and during detection. The acquired communication packets are input to the packet learning unit 202. Note that the acquisition unit 201 may be configured to acquire one or more communication packets from another device that collects the communication packets transmitted over the field network 110 or 111. Further, the acquisition unit 201 may acquire process data from a payload of the communication packet transmitted over the control network 108 or from the historian 106 during learning and during detection.

The packet learning unit 202 learns a normal characteristic of the communication pattern for each system state of a plant system during learning. The learning of a normal characteristic is performed by using a communication pattern (a single communication packet or a sequence of communication packets) used for learning classified on a system state basis. The packet learning unit 202 creates a model in which a system state and a normal characteristic of a communication pattern are associated with each other.

The determination unit 203 acquires process data from the historian 106 via the acquisition unit 201 during learning. The process data are data collected in various system states, which include data collected in system states that vary in accordance with an external factor caused by disturbance such as an environmental value such as an outside air temperature, a quality of a raw material supplied to a plant system, or the like or an internal factor caused by a setting of an actuator such as an automatic operation mode and a manual operation mode, a control parameter or a target value of PID control or the like, or the like for example. In the automatic operation mode, the setting of the field apparatus 109 is automatically controlled, and in the manual operation mode, the setting of the field apparatus 109 is adjusted manually by an operator. The determination unit 203 classifies process data used for learning into a plurality of system states and defines the classified system states as classes, respectively. The determination unit 203 may be configured to acquire process data from a payload of a communication packet transmitted over the control network 108.

The determination unit 203 acquires process data via the acquisition unit 201 during detection. The process data is acquired in substantially real time and processed by the determination unit 203. The determination unit 203 determines a class into which the process data is classified and outputs the system state defined by the class as the current system state.

The storage unit 204 stores a model created by the packet learning unit 202, information on a class of a system state classified by the determination unit 203, a current system state determined by the determination unit 203, or the like.

The detection unit 205 detects an abnormal communication pattern in the control network 108 based on a communication pattern and process data. For example, the detection unit 205 uses a model stored in the storage unit 204 to determine that one or more communication packets of an abnormal communication pattern are being transmitted if the characteristic of the communication pattern flowing in the control network 108 in the current system state does not match a normal characteristic. The detection unit 205 outputs a detection result to an external device such as a screen of the anomaly detection device 105, a PC of an information network, the HMI 102, the historian 106, or the like.

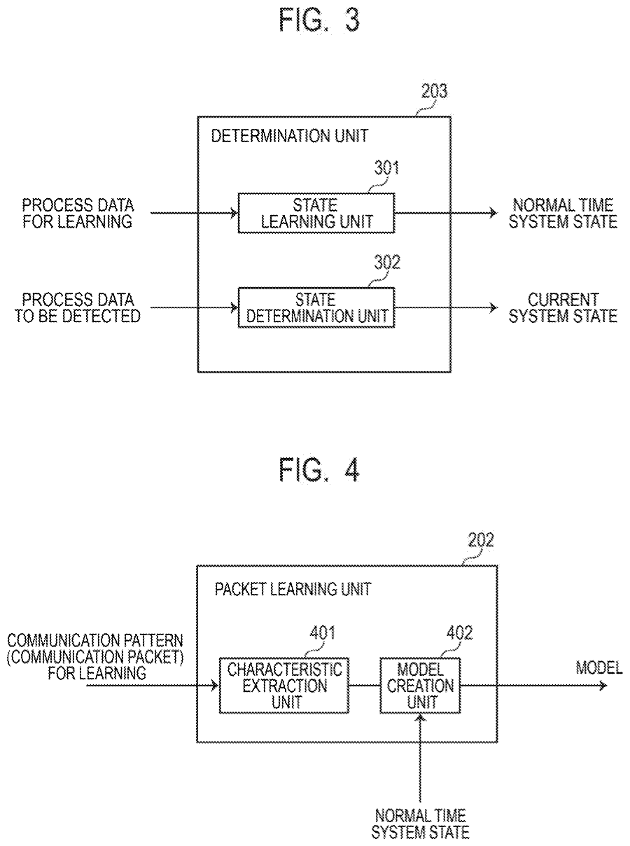

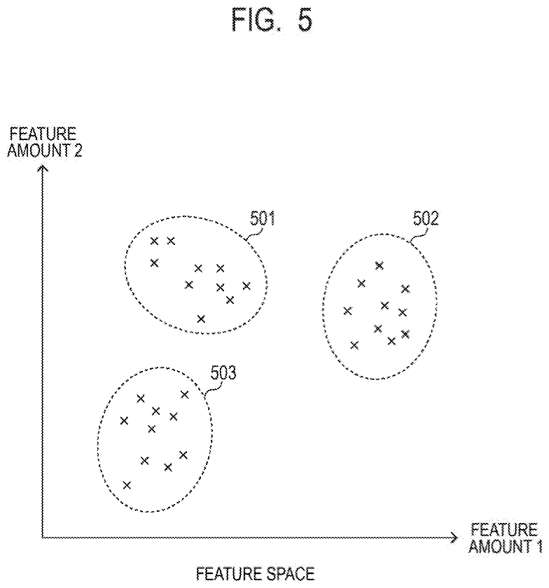

FIG. 3 is a detailed block diagram of the determination unit 203 according to the present example embodiment. The determination unit 203 includes a state learning unit 301 and a state determination unit 302. During learning, the state learning unit 301 extracts a feature amount (feature vector) from process data used for learning. For example, the state learning unit 301 aggregates multi-dimensional process data collected from the DCS 103 or the PLC 104 in lower-dimensional process data by using principal component analysis. The state learning unit 301 then classifies the process data into a plurality of classes of system states on a feature space. For example, as illustrated in FIG. 5, two feature amounts (feature amount 1 and feature amount 2) are extracted from process data, and two-dimensional feature space having axes of these feature amounts is formed. In the feature space, sets of process data located nearby are classified into classes 501, 502, and 503 as different system states, respectively. The extraction scheme of a feature amount is not limited to the principal component analysis, and deep learning, support vector machine (SVM), or the like may be used. The number of feature amounts is not limited to two and may be one or three or greater. The number of system states to be classified may be one without being limited to plural.

Further, the state learning unit 301 defines a system state corresponding to each class. For example, in FIG. 5, it is assumed that the feature amount 1 represents a water temperature and the feature amount 2 represents a material nature. In such a case, the class 501 is defined as a system state representing “a system state when the water temperature and the material nature are appropriate”, the class 502 is defined as a system state representing “a system state when the water temperature is high”, and the class 503 is defined as a system state representing “a system state when the material nature is poor”. In such a way, the state learning unit 301 can extract various system states that vary in accordance with an external factor or an internal factor in a plant system based on process data used for learning. The process data during learning reflects a normal time system state of a plant system. The feature amount may be a combination such as a sum of two or more types of process data weighted, respectively, without being limited to one type of process data such as a water temperature or a material nature.

During detection, the state determination unit 302 extracts a feature amount from process data to be detected. The process data to be detected is process data collected in real time from the DCS 103 or the PLC 104 and reflects the current system state of the plant system. The state determination unit 302 forms a feature space in the same manner as the state learning unit 301 and identifies the position on the feature space of process data to determine a class into which the process data is classified. The state determination unit 302 outputs a system state corresponding to the determined class.

FIG. 4 is a detailed block diagram of the packet learning unit 202 according to the present example embodiment. The packet learning unit 202 includes a characteristic extraction unit 401 and a model creation unit 402. During learning, the characteristic extraction unit 401 calculates a characteristic of a communication pattern used for learning (normal characteristic). Herein, for example, the calculated characteristic may be a communication frequency, a cycle, or the like for each type of commands based on a command included in a communication pattern or a communication frequency, a cycle, or the like for each type of sequences (time-series arrangement order) of respective commands included in a series of communication packets having order. Herein, the command can include a MAC address, an IP address, a port number, or the like and further a command type such as read/write, an address used for performing read/write, data used for performing write, read data, or the like.

Further, during learning, the model creation unit 402 associates an input system state with a normal characteristic of a communication pattern calculated by the characteristic extraction unit 401. Herein, the input system state is a state extracted from process data used for learning by the state learning unit 301 and includes one or a plurality of different system states. The model creation unit 402 outputs a normal characteristic of a communication pattern in each system state as a model.

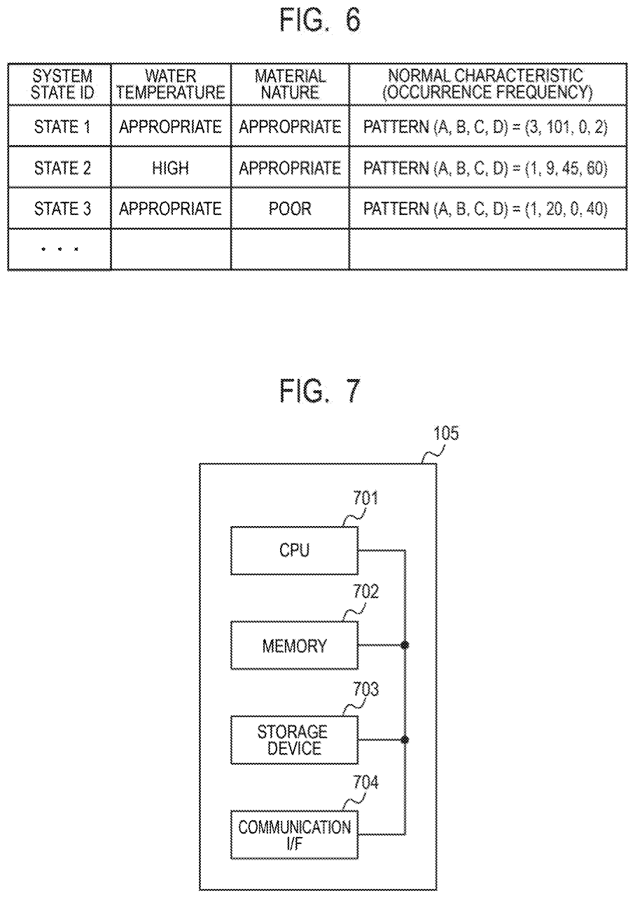

FIG. 6 is a table illustrating an example of a model according to the present example embodiment. The model includes information on a system state identification (ID), attribute information such as a water temperature, a material nature, a control parameter, or the like that are primary factors determining a system state, a normal characteristic of a communication pattern in each system state, or the like. The system state ID is a symbol that is attached for each system state and identifies a system state. With respect to the attribution information, the state 1 represents a system state where the water temperature and the material nature are appropriate, for example. Similarly, the state 2 represents a system state where the water temperature is high and the material nature is appropriate, and the state 3 represents a system state where the water temperature is appropriate but the material nature is poor. The attribute information is not limited to a water temperature, a material nature, or a control parameter but may be any information included in sensor data and actuator data, for example. Note that the attribute information is not essential as a required component of a model.

In the example of FIG. 6, the normal characteristic is represented as the occurrence frequency for each type (A to D) of a communication pattern within a predetermined period. For example, in the state 1, a state where the communication patterns A to D occur at frequencies of 3, 101, 0, and 2, respectively, is normal. Similarly, in the state 2, a state where the communication patterns A to D occur at frequencies of 1, 9, 45, and 60, respectively, is normal, and in the state 3, a state where the communication patterns A to D occur at frequencies of 1, 20, 0, and 40, respectively, is normal. The normal characteristic is an index used for determining whether or not an abnormal communication pattern is occurring and is compared with a characteristic of a communication pattern calculated during the operation. The communication pattern for which the occurrence frequency is determined may be not only a single communication packet but also a sequence of communication packets having a periodicity and ordering. Further, the normal characteristic may be an occurrence probability for each type of communication patterns.

FIG. 7 is a hardware block diagram of the anomaly detection device 105 according to the present example embodiment. The anomaly detection device 105 has a CPU 701, a memory 702, a storage device 703, and a communication interface (I/F) 704. The CPU 701 performs a predetermined operation in accordance with a program stored in the memory 702 or the storage device 703 and has a function of controlling each component of the anomaly detection device 105. Further, the CPU 701 executes a program that implements each function of the acquisition unit 201, the packet learning unit 202, the determination unit 203, and the detection unit 205.

The memory 702 is formed of a random access memory (RAM) or the like and provides a memory region required for the operation of the CPU 701. Further, the memory 702 may be used as a buffer region that realizes each function of the acquisition unit 201, the packet learning unit 202, the determination unit 203, and the detection unit 205. The storage device 703 is a flash memory, a solid state drive (SSD), a hard disk drive (HDD), or the like, for example, and provides a storage region that realizes the function of the storage unit 204.

The storage device 703 stores a basic program such as operating system (OS) that operates the anomaly detection device 105, an application program that performs a learning process and an anomaly detection process, or the like. The communication interface 704 is a module that communicates with an external device based on a standard such as universal serial bus (USB), Ethernet (registered trademark), Wi-Fi (registered trademark), or the like.

Note that the hardware configuration illustrated in FIG. 7 is an example, and a device other than the above may be added or some of the devices may be omitted. For example, some of the functions may be provided by another device via a network, or the functions forming the present example embodiment may be implemented by being distributed in a plurality of devices.

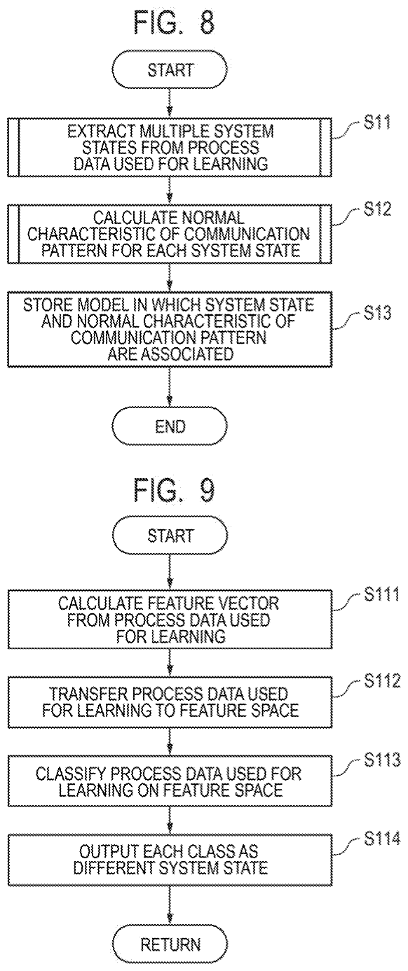

FIG. 8 is a flowchart illustrating the operation of the anomaly detection device 105 according to the present example embodiment. Herein, the operation during learning is described. First, the determination unit 203 extracts a plurality of system states from input process data used for learning (step S11). For example, the process data used for learning is classified into a plurality of classes, and a system state corresponding to each class is defined. The determination unit 203 stores the extracted system state and outputs the system state to the packet learning unit 202.

Subsequently, the packet learning unit 202 calculates a normal characteristic on a system state basis from a communication pattern used for learning acquired by the acquisition unit 201 (step S12). For example, an occurrence frequency within a predetermined period regarding the communication pattern is calculated as a normal characteristic. The packet learning unit 202 creates a model in which the calculated normal characteristic and a system state are associated and stores this model in the storage unit 204 (step S13).

FIG. 9 is a flowchart illustrating the operation of the determination unit 203 according to the present example embodiment. This flowchart illustrates the state extraction process (step S11) of FIG. 8 in detail. First, the state learning unit 301 calculates a feature vector (feature amount) from process data used for learning (step S111). For example, the state learning unit 301 calculates, as a feature amount, a type of data having a high contribution rate from multiple types of data included in the process data by using principal component analysis.

Subsequently, the state learning unit 301 generates a feature space formed of the feature vector and transfers the process data used for learning to the feature space (step S112). The state learning unit 301 classifies the process data into a plurality of classes on the feature space as illustrated in FIG. 5 (step S113) and outputs respective classes as different system states (step S114). For example, as illustrated in FIG. 6, the state learning unit 301 attaches a system state ID to each system state and describes a normal characteristic of a communication pattern in each system state or the like.

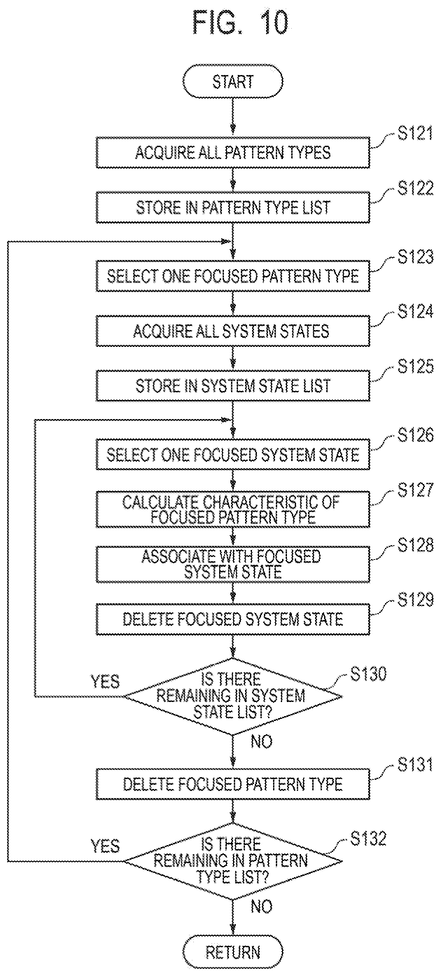

FIG. 10 is a flowchart illustrating the operation of the packet learning unit 202 according to the present example embodiment. This flowchart illustrates the characteristic calculation process (step S12) of FIG. 8 in detail. First, the characteristic extraction unit 401 acquires all the pattern types included in a communication pattern used for learning (step S121). For example, as the pattern type, a type of a command such as “read”, “write”, or the like is acquired.

The characteristic extraction unit 401 creates a pattern type list and stores all the acquired pattern types in this pattern type list (step S122). Herein, the characteristic extraction unit 401 selects one type to be focused on (focused pattern type) from the pattern type list (step S123). The characteristic extraction unit 401 acquires all the system states output from the state learning unit 301 in step S114 and input to the model creation unit 402 (step S124).

The characteristic extraction unit 401 creates a system state list and stores all the acquired system states in this system state list (step S125). Herein, the characteristic extraction unit 401 selects one state to be focused on (focused system state) from the system state list (step S126). The characteristic extraction unit 401 calculates a normal characteristic of a focused pattern type (step S127).

For example, the characteristic extraction unit 401 counts the total number (Nt) of patterns that have occurred in a period corresponding to the focused system state for a communication pattern used for learning. Furthermore, the characteristic extraction unit 401 counts the number (N) of patterns of the focused pattern type that have generated in a period corresponding to the focused system state for a communication pattern used for learning. The characteristic extraction unit 401 calculates a normal occurrence frequency (Fn) per unit time on a type basis based on the number (N) of patterns of the focused pattern type. Further, the number (N) of patterns on a type basis is divided by the total number (Nt) of all the types of patterns, and thereby a normal occurrence probability (Pn) for the focused pattern type is calculated.

The model creation unit 402 creates a model by associating a normal characteristic such as the normal occurrence frequency (Fn) calculated by the characteristic extraction unit 401 with the focused system state (step S128). The created model is stored in the storage unit 204. The characteristic extraction unit 401 deletes the focused system state from the system state list (step S129).

The characteristic extraction unit 401 determines whether or not there is a system state remaining in the system state list (step S130). If there is a remaining system state (step S130, YES), the characteristic extraction unit 401 returns to step S126 and selects a new focused system state from the system state list. For the new focused system state, the characteristic calculation process to the state deletion process (steps S127 to S129) are performed again. If there is no remaining system state (step S130, NO), the characteristic extraction unit 401 deletes the focused pattern type from the pattern type list (step S131).

The characteristic extraction unit 401 determines whether or not there is a pattern type remaining in the pattern type list (step S132). If there is a remaining pattern type (step S132, YES), the characteristic extraction unit 401 returns to step S123 and selects a new focused pattern type from the pattern type list. For the new focused pattern type, the state acquisition process to the type deletion process (steps S124 to S131) are performed again. If there is no remaining pattern type (step S132, NO), the process returns to the flowchart of FIG. 8. The communication pattern to be subjected to learning may be not only a single communication packet but also a sequence of communication packets having a periodicity and ordering.

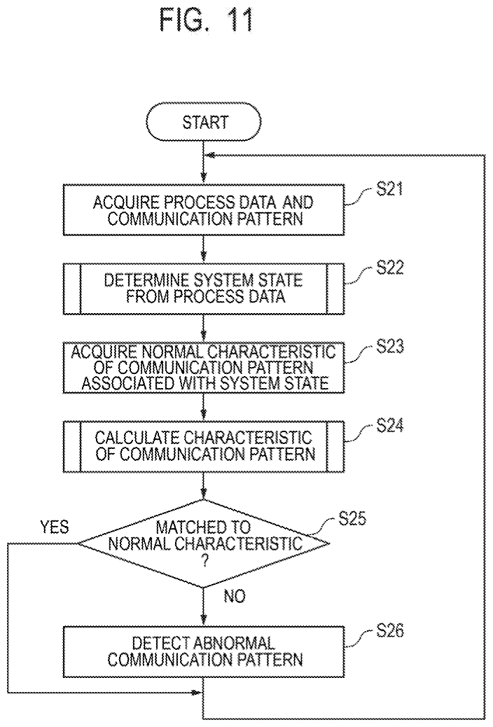

FIG. 11 is a flowchart illustrating the operation of the anomaly detection device 105 according to the present example embodiment. Herein, the operation during detection is described. First, the acquisition unit 201 acquires information on a current communication pattern (that is, a communication pattern to be detected), and the determination unit 203 acquires current process data (step S21). The determination unit 203 determines a system state of a plant system from the acquired process data (step S22) and uses a model stored in the storage unit 204 to acquire a normal characteristic associated with the system state (step S23).

Next, the detection unit 205 calculates a characteristic of the communication pattern based on the information on the communication pattern acquired by the acquisition unit 201 (step S24). For example, the detection unit 205 calculates the occurrence frequency per unit time for each type of the communication pattern as a characteristic of the communication pattern. The detection unit 205 determines whether or not the calculated characteristic matches a normal characteristic (step S25). Herein, matching may include a case of being similar or within a predetermined range without being limited to complete matching. For example, the detection unit 205 determines a similarity to a distribution of a normal characteristic for a distribution of occurrence frequencies per unit time on a type basis.

If it is determined that there is no matching to the normal characteristic (step S25, NO), the detection unit 205 detects that one or more communication packets of an abnormal communication pattern are being transmitted (step S26) and outputs alert information. The detection unit 205 also considers a control anomaly as being occurring if it is determined that there is no corresponding system state (there is a system state anomaly) in the state determination process (step S22). On the other hand, if it is determined that there is a matching to the normal characteristic (step S25, YES), the detection unit 205 consider no packet of an abnormal communication pattern as being transmitted. The process of the flowchart returns to step S21, and the process of steps S21 to S26 is repeated at a predetermined cycle. The communication pattern to be detected may be not only a single communication packet but also a sequence of communication packets having a periodicity and ordering.

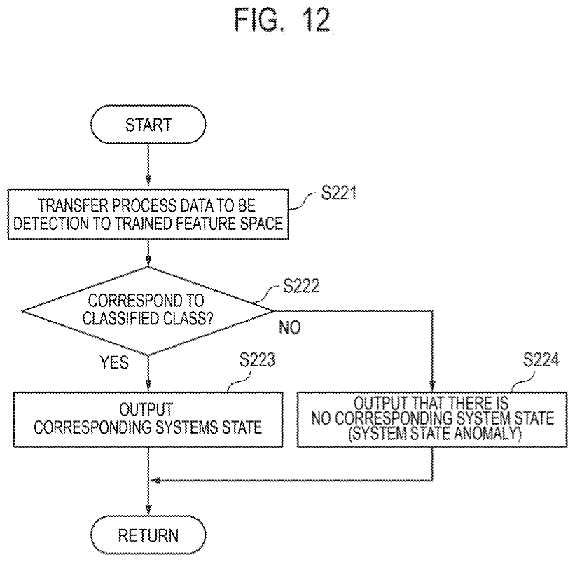

FIG. 12 is a flowchart illustrating the operation of the determination unit 203 according to the present example embodiment. This flowchart illustrates the state determination process (step S22) of FIG. 11 in detail. First, the state determination unit 302 transfers the current process data to the trained feature space (step S221). The trained feature space is generated in advance by the state learning unit 301 as described above.

The state determination unit 302 determines whether or not the process data corresponds to any of the classes classified during the learning (step S222). That is, the state determination unit 302 checks the position of transferred process data on the feature space and determines a class including the process data. If it is determined that the process data corresponds to the classified class (step S222, YES), the state determination unit 302 outputs a system state corresponding to the corresponding class (step S223). If it is determined that the process data does not correspond to the classified class (step S222, NO), the state determination unit 302 outputs that the current process data does not correspond to any of the system states defined during the learning (there is a system state anomaly) (step S224).

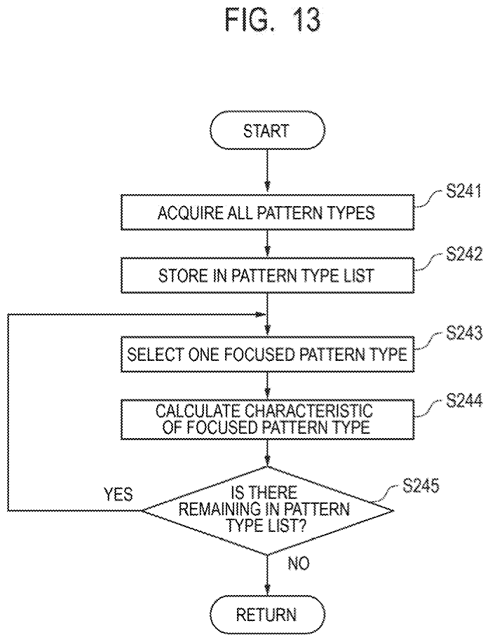

FIG. 13 is a flowchart illustrating the operation of the detection unit 205 according to the present example embodiment. This flowchart illustrates the characteristic calculation process (step S24) of FIG. 11 in detail. First, the detection unit 205 acquires all the pattern types included in the current communication pattern (step S241). An example of the pattern type acquired here may be the same pattern type as acquired by the packet learning unit 202.

The detection unit 205 creates a pattern type list and stores all the acquired pattern types in this pattern type list (step S242). Herein, the detection unit 205 selects one type to be focused on (focused pattern type) from the pattern type list (step S243).

The detection unit 205 calculates a characteristic of the focused pattern type (step S244). For example, the detection unit 205 counts the total number (Nt) of patterns that have occurred within a predetermined period for the current communication pattern. Furthermore, for the current communication pattern, the characteristic extraction unit 401 counts the number (N) of patterns of the focused pattern type that have occurred within a predetermined period. The detection unit 205 calculates a normal occurrence frequency (Fn) per unit time on a type basis based on the number (N) of patterns of the focused pattern type. Further, the number (N) of patterns on a type basis is divided by the total number (Nt) of all the types of patterns, and thereby an occurrence probability (P) for the focused pattern type is calculated. The calculated characteristic is stored in association with the focused pattern type.

The detection unit 205 determines whether or not a pattern type whose characteristic is not calculated remains in the pattern type list (step S245). If there is a remaining pattern type (step S245, YES), the detection unit 205 returns to step S243 and selects a new focused pattern type from the pattern type list. The characteristic calculation process (step S244) is performed again for the new focused pattern type. If there is no remaining pattern type (step S245, NO), the process returns to the flowchart of FIG. 11. The communication pattern to be detected may be not only a single communication packet but also a sequence of communication packets having a periodicity and ordering.

According to the present example embodiment, an abnormal communication pattern is detected on a network based on a communication pattern of one or more communication packets used for controlling a plant system and process data collected from the system. Since it is possible to extract various system states from the process data and detect an anomaly of the communication pattern (one or more communication packets) by using a model in accordance with the system state, it is possible to accurately perform anomaly detection.

By analyzing process data, it is possible to extract not only an operation mode based on a phase such as “startup”, “in operation”, “shutdown”, or “maintenance” that can be switched by the operator but also various system states in each phase. For example, various system states that vary in accordance with an external factor caused by an environmental value such as an outside air temperature, a quality of a raw material supplied to a plant system, or the like or an internal factor such as an automatic operation mode and a manual operation mode, a control parameter or a target value of PID control or the like, or the like can be extracted. Accordingly, since a model in accordance with the system states can be created in a more subdivided manner, detection accuracy can be improved.

As described above, the system state of a plant system changes due to an external factor such as an outside air temperature or an internal factor such as a control parameter. According to the present example embodiment, for example, when a command for supplying a cooling agent is supplied from an attacker even though the outside air temperature is low, the fact that an abnormal command that would not occur when the outside air temperature is low (that is, a command unsuitable for the system state) has been supplied can be promptly detected based on the system state learned from the process data such as the outside air temperature. Further, in a plant system in which the temperature inside a plant varies to a stable state or a transient state due to a change of the setting of the control parameter or the target value, when a command for changing a setting value is supplied from an attacker even though the temperature is in a stable state, the fact that an abnormal command that would not occur in the stable state has been supplied can be promptly detected based on the system state learned from the process data such as the temperature or the temporal change thereof.

### Second Example Embodiment

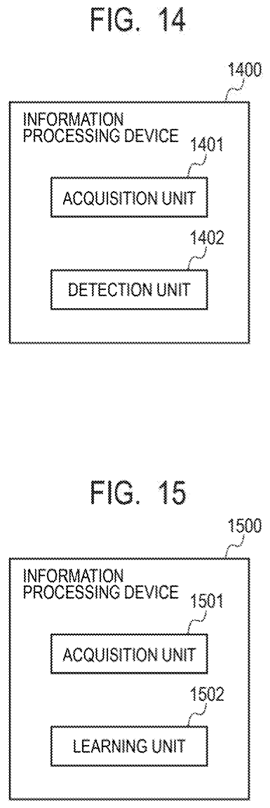

FIG. 14 is a schematic configuration diagram of an information processing device 1400 according to the present example embodiment. The information processing device 1400 has an acquisition unit 1401 and a detection unit 1402. The acquisition unit 1401 acquires a communication packet used for monitoring and controlling a system and process data collected from an apparatus installed in the system via a network. The detection unit 1402 detects an abnormal communication pattern on the network based on a correspondence between the communication pattern related to the communication packet and the process data. According to the information processing device 1400 of the present example embodiment, anomaly detection in an industrial control system can be accurately performed.

### Third Example Embodiment

FIG. 15 is a schematic configuration diagram of an information processing device 1500 according to the present example embodiment. The information processing device 1500 has an acquisition unit 1501 and a learning unit 1502. The acquisition unit 1501 acquires a communication packet used for monitoring and controlling a system and process data collected from an apparatus installed in the system via a network. The learning unit 1502 creates a model used for detecting an abnormal communication pattern of the communication packet on the network based on a correspondence between the communication pattern related to the communication packet and the process data. According to the information processing device 1500 of the present example embodiment, a model that enables accurate anomaly detection in an industrial control system can be obtained.

### Modified Example Embodiments

The present invention is not limited to the example embodiments described above and can be changed as appropriate within the scope not departing from the spirit of the present invention. For example, each configuration of the anomaly detection device 105 (FIG. 2), the determination unit 203 (FIG. 3), and the packet learning unit 202 (FIG. 4) is mere an example, and other components than is illustrated may be further provided. Further, a single component may be distributed in multiple components, or multiple components may be aggregated in a single component.

Further, the scope of each of the example embodiments includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the program described above is stored but also the program itself. Further, one or two or more components included in the example embodiments described above may be a circuit such as an application specific integrated circuit (ASIC), a field programmable gate array (FPGA), or the like configured to implement the function of each component.

As the storage medium, for example, a floppy (registered trademark) disk, a hard disk, an optical disk, a magneto-optical disk, a compact disk (CD)-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary Note 1)

An information processing device comprising:

an acquisition unit that acquires a communication packet used for monitoring and controlling a system and process data collected from an apparatus installed in the system via a network; and

a detection unit that detects an abnormal communication pattern on the network based on a correspondence between a communication pattern related to the communication packet and the process data.

(Supplementary Note 2)

The information processing device according to supplementary note 1 further comprising a determination unit that, based on a feature amount extracted from the process data, determines system states of the system into which the process data is classified,

wherein the detection unit detects the abnormal communication pattern by using a model representing a characteristic of the communication pattern in each of the system states.

(Supplementary Note 3)

The information processing device according to supplementary note 2, wherein the model represents a normal characteristic of the communication pattern in the systems states, and the detection unit determines that the abnormal communication pattern is occurring when the characteristic of the communication pattern does not match the normal characteristic.

(Supplementary Note 4)

The information processing device according to supplementary note 3, wherein the communication pattern includes a time-series command for the system, the characteristic of the communication pattern is represented by an occurrence frequency or an occurrence probability for each type of the command.

(Supplementary Note 5)

The information processing device according to any one of supplementary notes 1 to 4,

wherein the apparatus includes a sensor and an actuator installed in the system, and

wherein the process data includes sensor data measured by the sensor and actuator data indicating a setting of the actuator.

(Supplementary Note 6)

The information processing device according to supplementary note 5, wherein based on the process data, the determination unit classifies the system states determined by an external factor due to disturbance of the system and an internal factor due to a setting of the actuator.

(Supplementary Note 7)

An information processing method comprising:

acquiring a communication packet used for monitoring and controlling a system and process data collected from an apparatus installed in the system via a network; and

detecting an abnormal communication pattern of the communication packet on the network based on a correspondence between a communication pattern related to the communication packet and the process data.

(Supplementary Note 8)

A program that causes a computer to perform:

acquiring a communication packet used for monitoring and controlling a system and process data collected from an apparatus installed in the system via a network; and

detecting an abnormal communication pattern of the communication packet on the network based on a correspondence between a communication pattern related to the communication packet and the process data.

(Supplementary Note 9)

An information processing device comprising:

an acquisition unit that acquires a communication packet used for monitoring and controlling a system and process data collected from an apparatus installed in the system via a network; and

a learning unit that creates a model used for detecting an abnormal communication pattern of the communication packet on the network based on a correspondence between a communication pattern related to the communication packet and the process data.

(Supplementary Note 10)

An information processing method comprising:

acquiring a communication packet used for monitoring and controlling a system and process data collected from an apparatus installed in the system via a network; and

learning a model used for detecting an abnormal communication pattern of the communication packet on the network based on a correspondence between a communication pattern related to the communication packet and the process data.

### REFERENCE SIGNS LIST

10 industrial control system
101 engineering station
102 HMI
103 DCS
104 PLC
105 anomaly detection device (information processing device)
106 historian
107 firewall
108 control network
109 field apparatus
110, 111 field network
120 external network
201 acquisition unit
202 packet learning unit
203 determination unit
204 storage unit
205 detection unit
301 state learning unit
302 state determination unit
401 characteristic extraction unit
402 model creation unit
501, 502, 503 class
701 CPU
702 memory
703 storage device
704 communication I/F
1400, 1500 information processing device
1401, 1501 acquisition unit
1402 detection unit
1502 learning unit

1. An information processing device comprising:
an acquisition unit that acquires a communication packet used for monitoring and controlling a system and process data collected from an apparatus installed in the system via a network; and
a detection unit that detects an abnormal communication pattern on the network based on a correspondence between a communication pattern related to the communication packet and the process data.

2. The information processing device according to claim 1 further comprising a determination unit that, based on a feature amount extracted from the process data, determines system states of the system into which the process data is classified,
wherein the detection unit detects the abnormal communication pattern by using a model representing a characteristic of the communication pattern in each of the system states.

3. The information processing device according to claim 2, wherein the model represents a normal characteristic of the communication pattern in the systems states, and the detection unit determines that the abnormal communication pattern is occurring when the characteristic of the communication pattern does not match the normal characteristic.

4. The information processing device according to claim 3, wherein the communication pattern includes a time-series command for the system, the characteristic of the communication pattern is represented by an occurrence frequency or an occurrence probability for each type of the command.

5. The information processing device according to claim 1,
wherein the apparatus includes a sensor and an actuator installed in the system, and
wherein the process data includes sensor data measured by the sensor and actuator data indicating a setting of the actuator.

6. The information processing device according to claim 5, wherein based on the process data, the determination unit classifies the system states determined by an external factor due to disturbance of the system and an internal factor due to a setting of the actuator.

7. An information processing method comprising:
acquiring a communication packet used for monitoring and controlling a system and process data collected from an apparatus installed in the system via a network; and
detecting an abnormal communication pattern of the communication packet on the network based on a correspondence between a communication pattern related to the communication packet and the process data.

8. A non-transitory storage medium storing a program that causes a computer to perform:
acquiring a communication packet used for monitoring and controlling a system and process data collected from an apparatus installed in the system via a network; and
detecting an abnormal communication pattern of the communication packet on the network based on a correspondence between a communication pattern related to the communication packet and the process data.

9. An information processing device comprising:
an acquisition unit that acquires a communication packet used for monitoring and controlling a system and process data collected from an apparatus installed in the system via a network; and
a learning unit that creates a model used for detecting an abnormal communication pattern of the communication packet on the network based on a correspondence between a communication pattern related to the communication packet and the process data.

10. An information processing method comprising:
acquiring a communication packet used for monitoring and controlling a system and process data collected from an apparatus installed in the system via a network; and
learning a model used for detecting an abnormal communication pattern of the communication packet on the network based on a correspondence between a communication pattern related to the communication packet and the process data.
